(19) United States
(12) Patent Application Publication
(10) Pub. No.: US 2008/0142247 A1
(43) Pub. Date: Jun. 19, 2008

(54) Electrical cable, and power supply system provided therewith

(76) Inventor: Jed Hacker, Brooklyn, NY (US)

Correspondence Address: Ilya Zborovsky, 6 Schoolhouse Way, Dix Hills, NY, 11746, US

(21) Appl. No.: 11/640,644

(22) Filed: Dec. 18, 2006

(51) Int. Cl. H01B 7/00

(52) U.S. Cl. 174/115

(57) ABSTRACT

An electric cable has two groups of bundles including a first group of bundles connectable to a negative pole of a power source and a second group of bundles connectable to a positive pole of the power source, each of the groups of bundles include three bundles, each of the three bundles of each of the group of bundles include two bundles having a same smaller diameter and, a third bundle having a larger diameter and the two bundles of the three bundles of each of the groups of the bundles have at least one wire of a larger diameter, and the third bundle of the three bundles of each of the groups of the bundles has at least one wire of a smaller diameter.

### BACKGROUND OF THE INVENTION

The present invention relates to a new electrical cable, as well as to a power supply system provided with it, in particular for alternating current (voltage) use.

Today technology requires applies more stringent voltage requirements from alternating current wall sockets. However, there are factors, such as noise and phasing ability, that the present standard wires or power cords can not connect. The same holds true for house and building internal wires. They are antiquated and not really efficient as to power, electrical consumption, etc. In the last ten years, the average household has about twice the amount of transformer controlled appliances than before. Re-examination of wire designs therefore could prove beneficial in terms of performance and economy.

### SUMMARY OF THE INVENTION

Accordingly, it is an object of the present invention to provide an electrical cable which is a further improvement of the existing electrical cables.

It is also an object of the present invention to provide a power supply system with the electrical cable, which is an improvement of the existing power supplies.

In keeping with these objects and with others which will become apparent hereinafter, one feature of the present invention resides, briefly stated, in an electric cable, comprising two groups of bundles including a first group of bundles connectable to a negative pole of a power source and a second group of bundles connectable to a positive pole of the power source, each of said groups of bundles including three bundles, each of said three bundles of each of said group of bundles including two bundles having a same smaller diameter and being operative for canceling noise characteristics of each other, while a third bundle of said three bundles of each group of bundles has a larger diameter and is operative for controlling frequency and propagation of current, wherein said two bundles of said three bundles of each of said groups of said bundles have at least one wire of a larger diameter, wherein said third bundle of said three bundles of each of said groups of said bundles has at least one wire of a smaller diameter.

Another feature of the present invention resides, briefly stated, in a system of power having a negative pole and a positive pole; a single consumer; and an electrical cable connecting said negative pole and said positive pole of said source of power with said single consumer, said electrical cable including two groups of bundles including a first group of bundles connectable to a negative pole of a power source and a second group of bundles connectable to a positive pole of the power source, each of said groups of bundles including three bundles, each of said three bundles of each of said group of bundles including two bundles having a same smaller diameter and being operative for canceling noise characteristics of each other, while a third bundle of said three bundles of each group of bundles has a larger diameter and is operative for controlling frequency and propagation of current, wherein said two bundles of said three bundles of each of said groups of said bundles have at least one wire of a larger diameter, wherein said third bundle of said three bundles of each of said groups of said bundles has at least one wire of a smaller diameter.

When the electrical cable is designed and the power supply is used in the electrical cable in accordance with the present invention, new opportunities are provided in frequency and propagation adjustments according to specific size and use for its intended application and is not solely limited for alternating current power cord use. Connecting cables for home entertainment, musical instruments, etc., will also benefit from this invention.

The electrical cable in this application is based on multiple injection scale of voltage. The wire size used are based on the Brown and Sharper American Wire Gauge System, easily convertible to the metric system for international use.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a cross-section of an electrical cable in accordance with the present invention;

FIG. 2 is a view showing a power supply system with the inventive electrical cable; and

FIG. 3 is a view showing a cross-section of an electrical cable in accordance with another embodiment of the invention.

### DESCRIPTION OF THE PREFERRED EMBODIMENTS

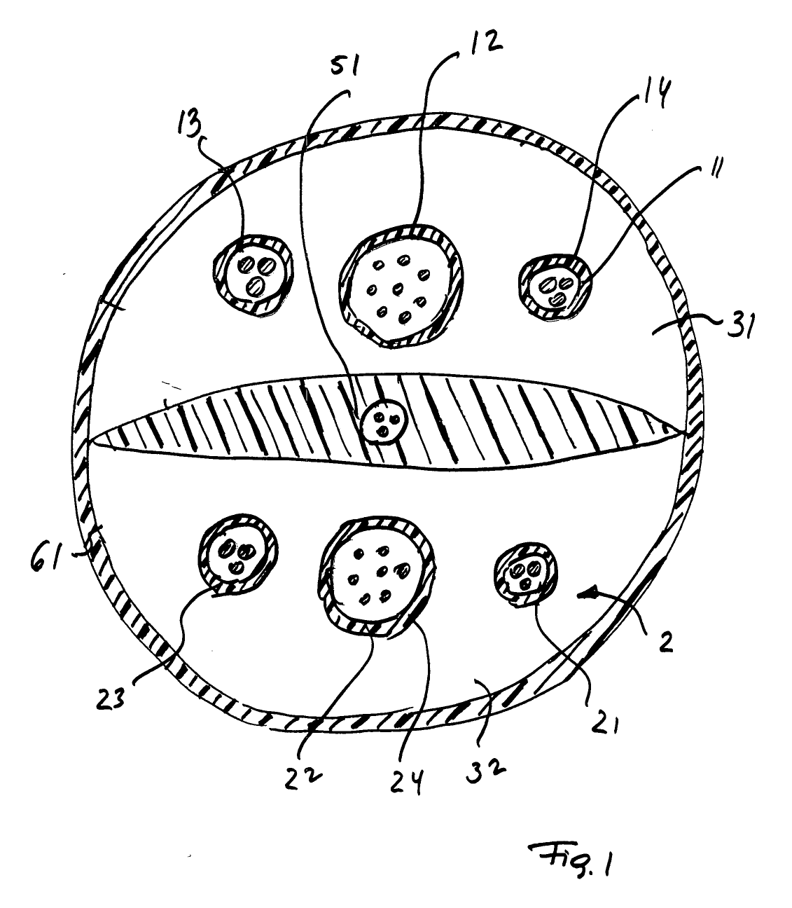

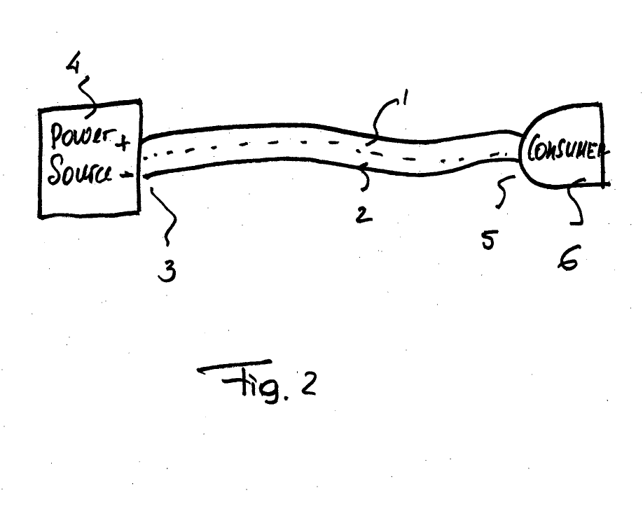

As you can see from FIG. 1, an electrical cable in accordance with the present invention includes two groups of bundles which are generally identified with reference numerals 1 and 2. As shown in FIG. 2, one end of the bundle groups 1 and 2 is connected to a positive pole and a negative pole correspondingly of a power source 4, for example a socket and the like, while the other end 5 is connected to a single consumer.

The bundle group 1 includes three bundles 11, 12, and 13, while the bundle group 2 includes 21, 22 and 23. The bundles 11 and 13 have wires or strands of wires of the same size (transverse cross-section). They also have the same number of wires or wire strands. Also, the bundles 11 and 13 have the same transverse cross-section or size.

Similarly, the bundles 21 and 23 have wires or strands of wires of the same size. The bundles 21 and 23 have the same number of the wires or wire strands. Finally, the bundles 21 and 23 have the transverse cross-section or size.

The bundles 12 and 22 have a larger diameter than the bundles 11, 13, 21, 23. At the same time the bundles 12 and 22 have wires or strands of wires of a smaller diameter than the wires in the bundles 11, 13 and 21, 23. The transverse cross-section of the wires in the bundles 12 and 22 is smaller than the transverse cross-sections of the wires in the bundles 11, 13, 21, 23.

The identical size bundles 11 and 13 of the bundle group I act as a noise filter or limiter. In other words, the bundles 11 and 13 cancel out each other's noise characteristics due to the same size wires. The same is true for the bundles 21 and 23 of the bundle group 2. These identical size bundles also act as a noise filter or limiter, and cancel out each others noise characteristics due to the same size wire. The bundles 12 and 22 are configured to control the frequency and propagation.

The bundles 11, 12, 13 are embedded in a core 31 and the bundles 21, 22, 23 are embedded in a core 32; The bundles 11, 12, 13 are sheathed or jacketed by a material 14, while the bundles 21, 22 and 23 are sheathed or jacketed by a material 24. An outer cable jacket is identified with reference numeral 61 and can be composed of a plastic material. The electrical cable in accordance with the present invention further has an additional independent bundle 51 which is a ground wire.

As an example of the bundles in the electrical cable in accordance with the present invention the following can be presented.

The bundles 11 and 13 in the bundle group I and the bundles 21, 23 in the bundle group 2 are bundles of 22-7×30. In other words, the gauge number of each of the bundles 11, 13, 21, 23 is 22, the number strands of wires is 7, and the gauge number each of the wires or strands of wires is 30.

The bundles 12 and 22 can be the bundles 20-105×40. In other words, the bundles 12 and 22 can be the bundles of 20 gauge, they have 105 wires or strands of wires, and the gauge of the wires or strands of wires is 40.

The gauge number of each bundle 11, 13, 21, 23 is therefore by 2 numbers smaller than the gauge number of each of the bundles 12 and 22.

The scale voltage is determined by the size of the two identical carriers in direct proportion to the single frequency propagation carrier and to current capacity.

An additional factor is the size of stranding in the frequency carrier. Smaller size strandings are used for higher propagation depending upon appliance applications.

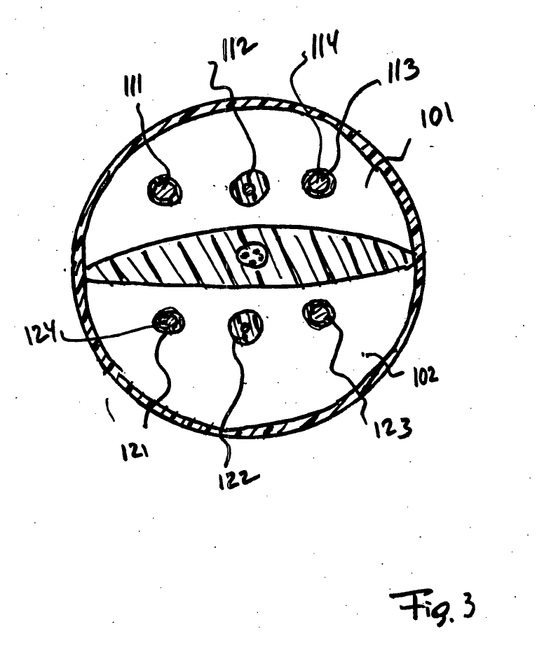

FIG. 3 shows a solid core wire cable in accordance with the present invention. The solid core wire cable has two groups of bundles 101 and 102 connectable to a positive pole and a negative pole correspondingly. The bundle group 101 includes two bundles 111 and 113 of a smaller diameter and each having a single wire 114 of a larger diameter, while a bundle 112 has a larger diameter and a single wire of a smaller diameter. The bundle group 102 has two bundles 121 and 123 of a smaller diameter and a single wire 124 of a larger diameter, while the bundle 122 has a larger diameter and a single wire of a smaller diameter.

It will be understood that each of the elements described above, or two or more together, may also find a useful application in other types of constructions differing from the types described above.

While the invention has been illustrated and described as embodied in an electrical cable, and power supply system provided therewith, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An electric cable, comprising two groups of bundles including a first group of bundles connectable to a negative pole of a power source and a second group of bundles connectable to a positive pole of the power source, each of said groups of bundles including three bundles, each of said three bundles of each of said group of bundles including two bundles having a same smaller diameter and being operative for cancelling noise characteristics of each other, while a third bundle of said three bundles of each group of bundles has a larger diameter and is operative for controlling frequency and propagation of current, wherein said two bundles of said three bundles of each of said groups of said bundles having said smaller diameter have at least one wire of a larger diameter, wherein said third bundle of said three bundles of each of said groups of said bundles having said larger diameter has at least one wire of a smaller diameter.

2. An electrical cable as defined in claim 1, wherein said two bundles of said three bundles of each of said groups having said smaller diameter has a plurality of wires of a larger diameter while said third bundle of said three bundles of each group having said larger diameter has a plurality of wires of a smaller diameter.

3. A system of power having a negative pole and a positive pole; a single consumer; and an electrical cable connecting said negative pole and said positive pole of said source of power with said single consumer, said electrical cable including two groups of bundles including a first group of bundles connectable to a negative pole of a power source and a second group of bundles connectable to a positive pole of the power source, each of said groups of bundles including three bundles, each of said three bundles of each of said group of bundles including two bundles having a same smaller diameter and being operative for cancelling noise characteristics of each other, while a third bundle of said three bundles of each group of bundles has a larger diameter and is operative for controlling frequency and propagation of current, wherein said two bundles of said three bundles of each of said groups of said bundles having said smaller diameter have at least one wire of a larger diameter, wherein said third bundle of said three bundles of each of said groups of said bundles having said larger diameter has at least one wire of a smaller diameter.

4. A system as defined in claim 3, wherein said two bundles of said three bundles of each of said groups having said smaller diameter has a plurality of wires of a larger diameter while said third bundle of said three bundles of each group having said larger diameter has a plurality of wires of a smaller diameter.

5. An electrical cable as defined in claim 1, further comprising two cores in which said first group of bundles and said second group of bundles are embedded correspondingly; an outer cable jacket surrounding said two cores; and an additional independent bundle provided with at least one ground wire, located between said third bundles having said larger diameter of said first and second groups of bundles, and having a smaller diameter than the larger diameter of said third bundles.

6. A system as defined in claim 4, further comprising two cores in which said first group of bundles and said second group of bundles are embedded correspondingly; an outer cable jacket surrounding said two cores; a plurality of sheathes each surrounding a respective one of said bundles of said first and second group of bundles; and an additional independent bundle provided with at least one ground wire, located between said third bundles having said larger diameter of said first and second groups of bundles, and having a smaller diameter than the larger diameter of said third bundles.

7. An electrical cable as defined in claim 1, wherein said two bundles having a same smaller diameter of said first group of bundles are located opposite to said two bundles having a same smaller diameter of said second group of bundles, and said third bundle having a larger diameter of said first group of bundles as located opposite to said third bundle having a larger diameter of said second group of bundles, and wherein in each of said first and second group of bundles said third bundle having a larger diameter is located between said two bundles having a same smaller diameter.

8. A system as defined in claim 3, wherein said two bundles having a same smaller diameter of said first group of bundles are located opposite to said two bundles having a same smaller diameter of said second group of bundles, and said third bundle having a larger diameter of said first group of bundles as located opposite to said third bundle having a larger diameter of said second group of bundles, and wherein in each of said first and second group of bundles said third bundle having a larger diameter is located between said two bundles having a same smaller diameter.
